(19) United States
(12) Patent Application Publication
(10) Pub. No.: US 2025/0332650 A1
(43) Pub. Date: Oct. 30, 2025

(54) ARROW TOOTH SAW HAVING ARROW-SHAPED CUTTER TOOTH

(71) Applicants: Hongjiang MA, College Grove, TN (US); Yanjun MA, College Grove, TN (US)

(72) Inventor: Hongjiang MA, College Grove, TN (US)

(21) Appl. No.: 19/032,792

(22) Filed: Jan. 21, 2025

(30) Foreign Application Priority Data
Feb. 28, 2024 (CN) 202410222889.1

(51) Int. Cl. B23D 61/02

(52) U.S. Cl. CPC B23D 61/02

(57) ABSTRACT

An arrow tooth saw having an arrow-shaped cutter tooth includes an arrow tooth unit, the arrow tooth unit includes an arrow tooth, an arrow tooth angle, an arrow tooth tip, arrow tooth edges, an arrow tooth head and an arrow tooth tail. Due to a sharp arrow tooth angle and long arrow tooth edges, a shear resistance of the arrow tooth is reduced to only one tenth or one in tens of a shear resistance of a straight saw with the same width, and the actual thickness of an arrow tooth edge is more than one order of magnitude thinner than a blunting value of a corresponding straight tooth required by sawing regulations. The present invention created a saw tooth that can continue sawing without the need for grinding repair while maintaining better sawing quality than that of a straight tooth.

### FIELD OF THE INVENTION

The invention relates to the technical field of shearing, and in particular, relates to an arrow tooth saw and a related shearing tool.

### THE PRIOR ARTS

Humans have known the sharp characteristic of a cutter point for a long time, and the characteristic has been widely applied to all aspects of production and daily life: for example, axes, kitchen knives, woodworking plane irons and straight tooth saws, with the disadvantages that the cutter point is necessarily polished constantly before continuing to work.

For an object with an arrow-like head, the principle of generating sharpness, significantly saving labor and energy during operation has been fully recognized for a long time and has been applied in various periods, especially in modern science, technology and daily life: for example, arrows of archery, wooden and iron plows used by farmers to plow fields in ancient times, bullet heads in modern times, missile heads, rocket heads, helicopter heads and locomotive heads in contemporary times.

With the continuous improvement of people's living standards and the development of science and technology, the application of the sawing industry is more and more extensive. No matter what kind of enterprises, sawing operation is often indispensable in their assembly line, especially, in the maintenance of equipment; and in daily life, every family is inseparable from the simple cutting of some objects.

At present, straight tooth saw commonly used in the sawing industry completely relies on the sharp cutter point for operation. As the wear of the cutter point becomes dull, the sawing efficiency will be reduced, so that sawing is more and more difficult, energy consumption is higher and higher, the sawing quality is reduced, and the operation cost is significantly increased. At this time, sawing can be restored after the cutter point is required to be sharpened. Grinding is time-consuming and laborious, and increases the processing cost of the product.

The operation of the straight tooth saw on a workpiece is to cut the cutter point (commonly known as wedge) horizontally and obliquely from the surface of the sawed workpiece to implement stripping processing, the wedge immediately bears all shear stress within the range of a tooth width, and the shear resistance is large; chips can only be discharged from the front of the wedge, the chip discharge space is single, the chip discharge deformation angle is large, the chip discharge is severe with high energy consumption generating high temperature; the increased temperature of the straight tooth during the sawing operation will accelerate the wear, even reduce the life of the tooth; the process is also prone to generate vibration, tooth breakage and harsh noise.

However, the straight tooth saw has been used all the time since the sawing tool was invented. Many people have made various modifications to the shape of the cutter point according to various requirements of different industries, but the straight tooth principle itself has never been changed.

### SUMMARY OF THE INVENTION

An objective of the present invention is to, in view of the shortcomings in the prior art, provide a brand-new energy-saving arrow tooth saw having an arrow-shaped cutter tooth with labor-saving property, ultralong service life and high quality, continued sawing without need to stop for grinding, including: an arrow tooth unit, where the arrow tooth unit includes an arrow tooth, an arrow tooth angle, an arrow tooth tip, arrow tooth edges, an arrow tooth height, an arrow tooth head and an arrow tooth tail.

The top view structure of the arrow tooth meets the following conditions: a rectangular element C is arranged on each of two sides of a center line of the arrow tooth, a length of the rectangular element C is an original thickness “a” (referencing corresponding sawing regulation's requirement for “grinding repair to blunting ratio”) of each of the arrow tooth edges, heights of two rectangular elements C perpendicular to the center line of the arrow tooth form an arrow tooth width, the rectangular element C is stretched into a parallelogram under a condition of keeping the height of the rectangular element C unchanged in a center line direction until an included angle between a hypotenuse of the parallelogram and the center line of the arrow tooth is half of an angle of the arrow tooth angle, and at this time, an entity figure surrounded by two parallelograms forms the arrow tooth; or the arrow tooth angle horizontally translates along the center line of the arrow tooth by a distance of the original thickness of one arrow tooth edge, and all acute angles and sides thereof generated in a translation process form the arrow tooth.

The arrow tooth angle is acute; the arrow tooth is formed by stretching a bottom view of the arrow tooth upward along an increasing radius of a circular saw blade in an arrow tooth height; a width of the arrow tooth tail gradually shrinks from top to bottom, with a maximum value being an top width of the arrow tooth and a minimum value being a bottom width of the arrow tooth; widths of other parts of the arrow tooth are formed in a plane by countless gradually enlarging connecting lines which are perpendicular to the center line of the arrow tooth or parallel to a baseline of the arrow tooth between two lines formed from the arrow tooth tip to the arrow tooth tail; an effective length of the arrow tooth is a height of a triangle formed by a bottom view of each arrow tooth; and a vertical shear resistance of the arrow tooth edges decreases with the decrease of the arrow tooth angle.

Further, the arrow tooth saw having the arrow-shaped cutter tooth further includes an arrow tooth saw unit, wherein the arrow tooth saw unit includes a saw blade body; an arrow tooth disk is arranged on a bottom surface of the arrow tooth; a minimum value of a width of the arrow tooth tail is greater than a width of the arrow tooth disk; and the width of the arrow tooth disk is greater than or equal to a width of the saw blade body.

Further, front and rear arrow tooth roots, or front, middle and rear arrow tooth roots are arranged below the arrow tooth disk; a tail end of each arrow tooth root is enlarged into a cylinder or a square column; a guide edge is arranged at a periphery of a side of the arrow tooth root; and arrow tooth root holes are formed in an outer edge of the saw blade body, and a guide groove is formed at a periphery of a side of each of the arrow tooth root holes.

Further, the arrow tooth, the arrow tooth disk and the arrow tooth roots are respectively welded firmly into a whole body in pairs after being respectively processed; then all the arrow tooth roots of all the arrow teeth and all the arrow tooth root holes of the saw blade body are subjected to one-step pressure injection and mounting; or the arrow tooth disk is directly welded with an outermost arc or edge of the saw blade body.

Further, a work operating direction of the arrow tooth is only from the arrow tooth head to the arrow tooth tail; and a warning mark is labeled on the saw blade body, so that the saw blade body is unable to be mounted reversely to cause a reverse operation.

The cutter point (that is, wedge) of the straight tooth saw is changed into an arrow tooth from horizontal inclined operation in one direction to vertical operation in two directions (horizontal and vertical directions), and the functional capacity of the straight tooth is completely altered, highlighting the sharper cutter point, greater labor saving, energy saving and higher quality sawing operation of the arrow tooth. The shearing of the arrow tooth edge on the workpiece can be approximately considered to conform to the nonelastic collision of two objections with significant inner energy, that is, to approximately conform to the law of conservation of momentum-impulse (nonconservation of energy). When the momentum is converted into impulse, the impulse force is inversely proportional to the action time: that is, the impulse force is large if the action time is short; and the impulse force is small if the action time is long. The arrow tooth prolongs the action time by increasing total length of the arrow tooth edges so as to greatly reduce the shear resistance. From the geometric point of view: when the straight tooth is changed into the arrow tooth, the shear resistance of the straight tooth is greatly diminished by the acute arrow tooth edges, so that the force on the arrow tooth is greatly reduced. Both arguments above reach the same conclusion independently: the shear resistance on a vertical surface of the arrow tooth edge is only one tenth or one in tens of the shear resistance of a front surface of the straight tooth during operation, translating into significant saving in labor and energy. Since the arrow tooth edge is formed by two parallelograms and its actual thickness being one order of magnitude thinner than the blunting value of the straight tooth, that is, the original thickness of the arrow tooth edge, this not only meets the requirement that the blunting value of the cutter point is less than the corresponding cut-off set by the sawing regulation for the straight tooth, but also maintain this value within peak performance range for continued high-quality sawing without deterioration. Thus, the arrow tooth achieves continuous high-quality shearing by relying on the greatly reduced shear resistance and the ultrahigh-standard and constant cutter point thickness of the arrow tooth edges, unlike the straight tooth, where continuous sawing completely relies on maintaining the sharp cutter point through repeated grinding. Since the upper and lower structures of the arrow tooth throughout its height are consistent, the sawing wear of the arrow tooth reduces the height and has no effect on the shear resistance. After the arrow tooth is worn out in height, the arrow tooth has completed its mission without polishing waste created during grinding, thereby making the best use of everything.

Since the volume of the heightened arrow tooth is more than ten times of the wear volume in one grinding cycle of the straight tooth (excluding the waste volume of grinding), and the shear resistance of the arrow tooth is more than one order of magnitude less than the shear resistance of the straight tooth, the wear rate is greatly reduced (much lower than the proportional reduction in the volume itself). The chip discharge of the arrow tooth is changed from single space of the straight tooth to two spaces, along two longer side wings of the arrow tooth edges. Low chip discharge volume, small chip discharge deformation angle, long discharge time and slow chip deformation are achieved on each side of the arrow tooth edge. Less heat is generated and transferred to the chips for a longer time, so that the temperature rise of the arrow tooth is milder during operation, improving the wear resistance of the arrow tooth and prolonging the life.

The above three reasons greatly prolong the life of the arrow tooth, which is a hundred time or even hundreds of times of one grinding cycle of the straight tooth. The above three reasons can reduce the demand on the hardness or strength grade of the manufacturing material of the arrow tooth, so that the sawing cost can be significantly reduced.

The manufacturing process and mounting of the arrow tooth are not complicated, even simpler than most of the straight teeth with complex shapes.

During the operation of the straight tooth, the disadvantages of significant vibration, tooth breakage, harsh noise and high temperature rise of the saw tooth are generated due to the large shear resistance. During the operation of the arrow tooth, the above incidental disadvantages will disappear or be greatly improved due to the significantly reduced force received by the tooth and decreased wear of the tooth.

Since the straight tooth has many disadvantages, the manufacturers have made various improvements and innovations on the cutter point shape of the straight tooth so as to meet various different sawing requirements. These innovations make the shape and manufacturing process of the straight tooth more complicated. However, the benefits brought by these innovations are insignificant in the face of the advantages of great labor saving, energy saving and high quality sawing of the arrow tooth, so the arrow tooth is actually a simplification, unification and promotion of various innovative straight teeth at present, and will definitely replace the straight teeth in most sawing operations in the future.

The present invention has the following beneficial effects: According to the arrow tooth saw having the arrow-shaped cutter tooth provided by the present invention, due to a sharp arrow tooth angle and long arrow tooth edges, a shear resistance of the arrow tooth is reduced to only one tenth or one in tens of a shear resistance of a straight saw with the same width, and the actual thickness of an arrow tooth cutter point is more than one order of magnitude thinner than a corresponding blunting value specified by sawing regulations, so that the real thickness of the cutter point of the arrow tooth edge is maintained within a range corresponding to the peak performance range of a straight tooth satisfying necessary condition required for high-quality operation, the arrow tooth's capability of continuous sawing without grinding is innovated, and the sawing quality of the arrow tooth is necessarily higher than the sawing quality of the straight tooth.

As the arrow tooth is a completely consistent structure throughout its height, the operation wear reduces the height of the arrow tooth, but has no effect on the continuous sawing quality.

The overall volume of the arrow tooth is more than ten times of the pure wear volume in one grinding cycle of the straight tooth; When the shearing resistance is greatly reduced, the wear rate will also be reduced drastically proportional to the resistance; and the low energy consumption of the operation of the arrow tooth will generate less heat and heat associated wear. All three factors together prolong the life of the arrow tooth, and the total effect can reach a hundred time to hundreds of times of one grinding cycle of the straight tooth, so that the ultralong life of the arrow tooth can be achieved.

The arrow tooth achieves continued powerful sawing without need to stop for grinding repair, so that quality-guaranteed, labor-saving, efficient and energy-saving sawing is achieved. When the same workpiece is sawed, compared with the straight tooth, the arrow tooth also reduces the demand on the hardness and strength grade of the material needed to build the tooth, further reduces the sawing cost.

In the sawing operation of the arrow tooth, the incidental disadvantages of vibration, tooth breakage, noise and heat generation are greatly decreased due to the great reduction of the sawing resistance and wear.

### BRIEF DESCRIPTION OF DRAWINGS

To describe the technical solutions in the examples of the present invention or in the prior art more clearly, the following briefly introduces the accompanying drawings required for describing the examples. Apparently, the accompanying drawings in the following description show merely some examples of the present invention, and a person of ordinary skill in the art may still derive other drawings from these accompanying drawings without creative efforts.

FIG. 1 is a top view of mounting of an arrow tooth circular saw with a 10-degree arrow tooth angle;

FIG. 2 is an elevation sectional view of mounting of an arrow tooth with a 10-degree arrow tooth angle and a circular saw blade;

FIGS. 3(a) and (b) are respectively top views of high and low parts of mounting of an arrow tooth circular saw with a 10-degree arrow tooth angle;

FIG. 4 is a detailed assembling diagram of an arrow tooth with a 10-degree arrow tooth angle and a circular saw blade;

FIG. 5 is a total assembling diagram of an arrow tooth with a 10-degree arrow tooth angle and a circular saw blade;

FIG. 6 is an alternative assembling diagram of an arrow tooth with a 10-degree arrow tooth angle and a circular saw blade; and

FIG. 7 is a detailed mounting diagram of an arrow tooth with a 10-degree arrow tooth angle and a band saw.

### DETAILED DESCRIPTION OF THE PREFERRED EMBODIMENTS

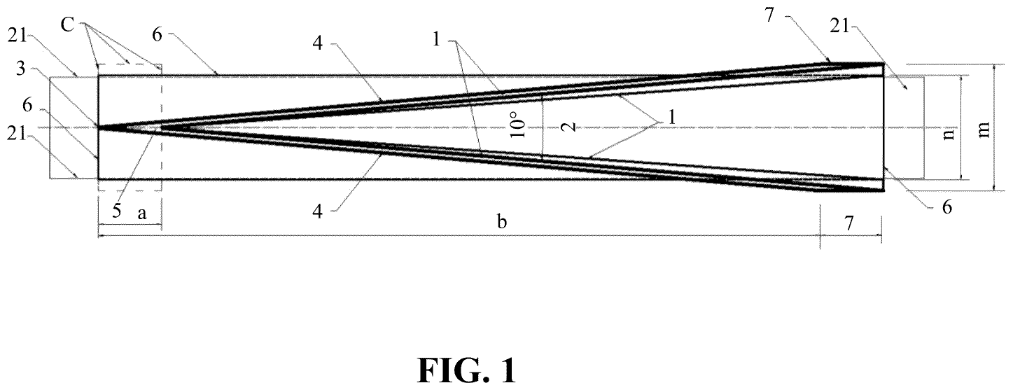

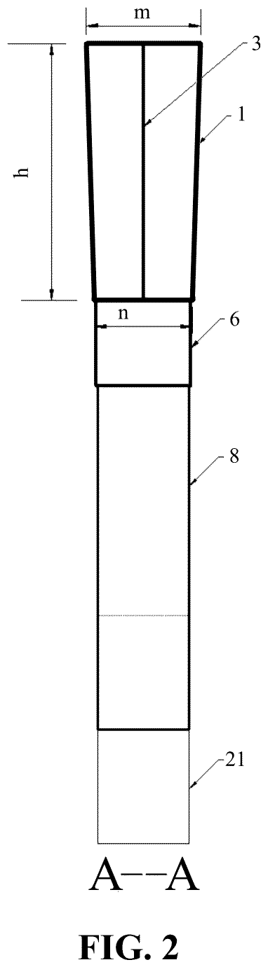

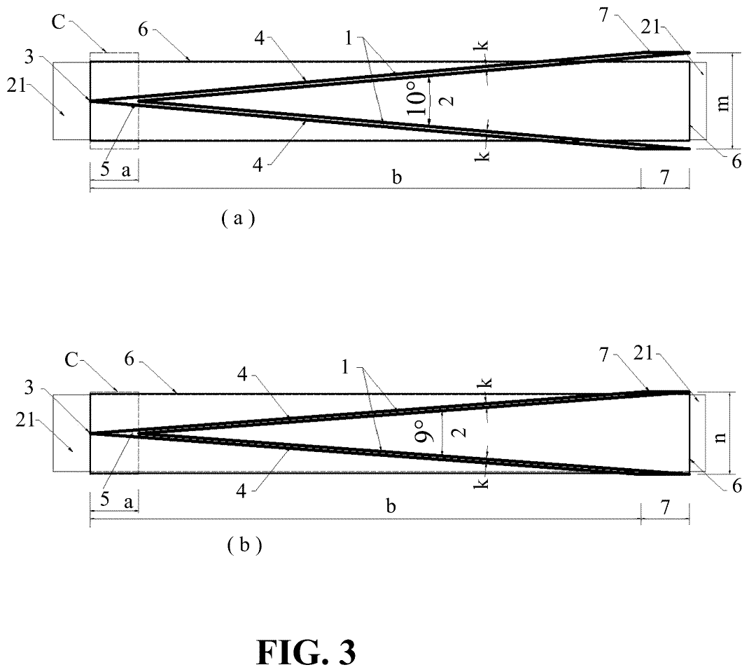

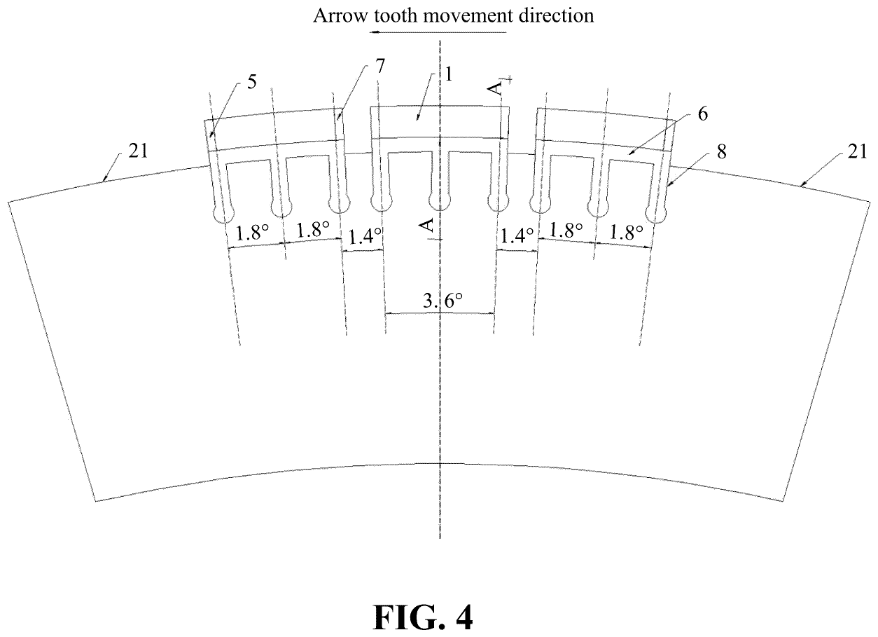

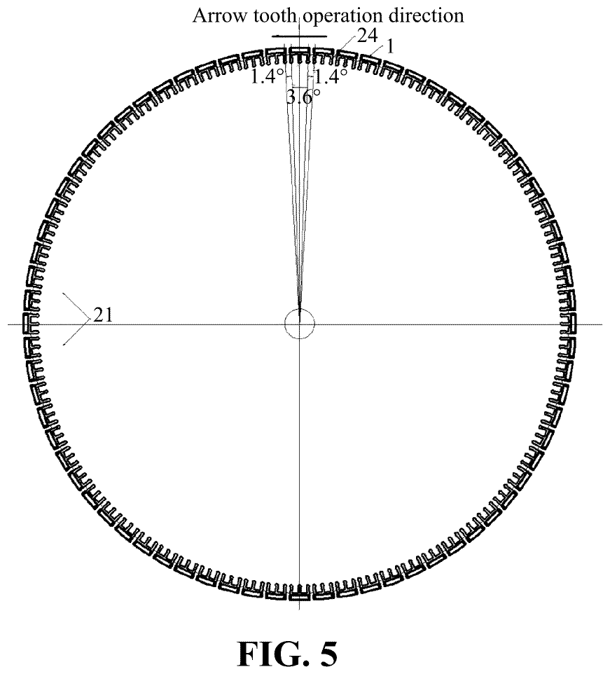

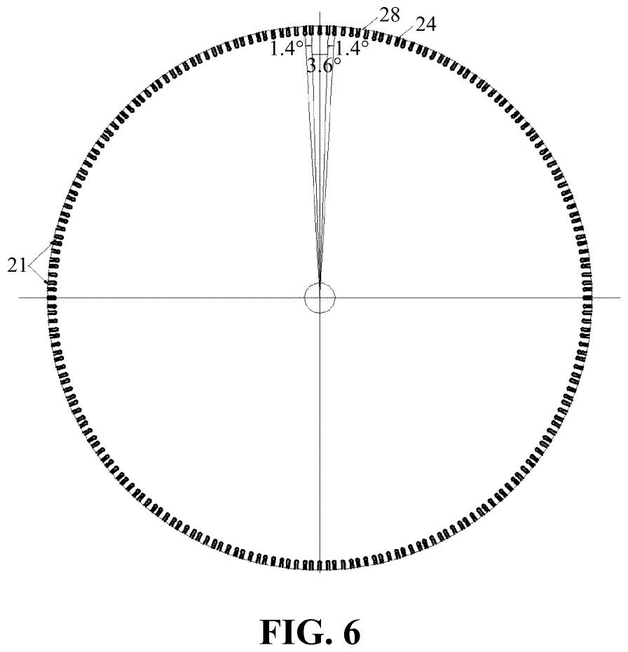

Referring to FIG. 1 to FIG. 7. the present invention provides an arrow tooth saw having an arrow-shaped cutter tooth, including: an arrow tooth unit and an arrow tooth saw unit, where the arrow tooth unit includes an arrow tooth 1, an arrow tooth angle 2, an arrow tooth tip 3, arrow tooth edges 4, an arrow tooth head 5 and an arrow tooth tail 7. A top view structure of the arrow tooth 1 meets the following conditions: a rectangular element C is arranged on each of two sides of a center line of the arrow tooth 1, a length of the rectangular element C is an original thickness a of each of the arrow tooth edges 4, heights of two rectangular elements C perpendicular to the center line of the arrow tooth form an arrow tooth width, the rectangular element C is stretched into a parallelogram under a condition of keeping the height of the rectangular element C unchanged in a center line direction until an included angle between a hypotenuse of the parallelogram and the center line of the arrow tooth is half of an angle of the arrow tooth angle 2, and at this time, an entity figure surrounded by two parallelograms forms the arrow tooth 1; or the arrow tooth angle 2 horizontally translates along the center line by a distance of the original thickness a of one arrow tooth edge 4, and all acute angles and sides thereof generated in a translation process form the arrow tooth 1.

The arrow tooth angle 2 is acute, and a space between the two arrow tooth edges 4 is hollow; and an actual thickness k of the arrow tooth edges 4 is at least one order of magnitude thinner than the original thickness a of the arrow tooth edges 4.

The arrow tooth 1 is formed by stretching from a bottom view of the arrow tooth 1 upward along an increasing radius of a circular saw blade in an arrow tooth height h. A width of the arrow tooth tail 7 gradually shrinks from top to bottom, with a maximum value being an top width m of the arrow tooth and a minimum value being a bottom width n of the arrow tooth. Widths of other parts of the arrow tooth 1 are formed in a plane by countless gradually enlarging connecting lines which are perpendicular to the center line of the arrow tooth 1 or parallel to a baseline of the arrow tooth 1 between two lines formed from the arrow tooth tip 3 to the arrow tooth tail 7; an effective length b of the arrow tooth 1 is a height of a triangle formed by a bottom view of each arrow tooth 1; and a vertical shear resistance of the arrow tooth edges 4 decreases with the decrease of the arrow tooth angle 2, with the value being only one tenth to one in tens of a vertical shear resistance of a straight tooth with the same width.

Due to the heightened arrow tooth 1, an overall volume of the arrow tooth 1 is more than ten times of a pure wear volume (excluding the grinding waste volume) in one grinding cycle of the straight tooth; moreover, since sawing resistance is reduced by more than one order of magnitude, a wear rate is greatly reduced (much lower than the proportional reduction in the resistance itself); and due to a lower energy consumption and less temperature rise of the arrow tooth 1 during operation, the wear of the arrow tooth 1 is further decelerated. These three factors prolong the life of the arrow tooth 1 by a hundred or even hundreds of times relative to one grinding cycle of the straight tooth.

The arrow tooth saw unit includes a saw blade body 21; an arrow tooth disk 6 is arranged on a bottom surface of the arrow tooth 1; a minimum value of a width of the arrow tooth tail 7 is greater than a width of the arrow tooth disk 6; and the width of the arrow tooth disk 6 is greater than or equal to a width of the saw blade body 21. Front and rear arrow tooth roots 8, or front, middle and rear arrow tooth roots 8 are arranged below the arrow tooth disk 6; a tail end of each arrow tooth root 8 is enlarged into a cylinder or a square column; a guide edge is arranged at a periphery of a side of the arrow tooth root 8; and arrow tooth root holes 28 are formed in an outer edge 24 of the saw blade body 21, and a guide groove is formed at periphery of a side of each of the arrow tooth root holes 28. The arrow tooth 1, the arrow tooth disk 6 and the arrow tooth roots 8 are respectively welded firmly into a whole body in pairs after being respectively processed; then all the arrow tooth roots 8 of all the arrow teeth 1 and all the arrow tooth root holes 28 of the saw blade body 21 are subjected to one-step pressure injection and mounting; or the arrow tooth disk 6 is directly welded with an outermost arc or edge of the saw blade body, which negate the need for the manufacturing and processing of the arrow tooth roots 8 and the arrow tooth root holes 28. A work operating direction of the arrow tooth 1 is only from the arrow tooth head 5 to the arrow tooth tail 7, and reverse mounting and operation are not allowed; and a warning mark is labeled on the saw blade body 21, so that the saw blade body 21 cannot be mounted reversely to cause a reverse operation. To make sure the arrow tooth 1 meet a high-quality shearing requirement when a workpiece is sheared, it is necessary to calculate a structural stress of the arrow tooth 1 first (a section resistance coefficient of the parallelogram is the same as that of a rectangle, so the parallelogram can be replaced with the rectangle during calculation). Under the premise of satisfying operational safety, it is necessary to select the optimal matching parameters through technical and economical comparison from various variables such as the size of the arrow tooth angle 2, the width m of the arrow tooth 1, the height h of the arrow tooth 1, the original thickness a of the arrow tooth edge 4, the effective length b of the arrow tooth 1, the distance between the arrow teeth 1, the material (including hardness or strength) of the arrow tooth 1, the diameter of the arrow tooth circular saw and the material of the saw blade body 21.

### Embodiment 1

As shown in FIG. 1 to FIG. 6, a circular saw with a diameter of 360 mm and formed by 72 arrow teeth 1 with 10-degree arrow tooth angles 2 is selected, a blunting value, that is the original thickness a of the arrow tooth edge 4, is selected as 1.0 mm, the actual thickness k of the arrow tooth edge 4 is 0.087 mm, the top width of the arrow tooth 1 is 2.0 mm, the bottom width n of the arrow tooth 1 is 1.7 mm, the height h of the arrow tooth 1 is 4.5 mm, the length of the arrow tooth head 5 and the arrow tooth tail 7 is 1.0 mm, the effective length b of the arrow tooth 1 is 12.69 mm, the width of the arrow tooth disk 6 is 1.65 mm, and the thickness of the circular saw body is 1.6 mm.

The operation of the arrow tooth 1 on the workpiece may be regarded as erecting the cutter point-wedge of the straight tooth vertically, pressing into a surface layer of the workpiece, gradually tearing through the surface layer of the workpiece into notches with different depths, thereby implementing various sawing operations.

Another analysis from a geometric standpoint: the 10-degree arrow tooth angle 2 is a small acute angle, each of the two arrow tooth edges 4 forms a 5-degree inclination angle with the center line of the arrow tooth 1, significantly dissolves the shear resistance received by the cutter point of the straight tooth with the same width, which is now only 8.7% of the original value; and at the moment when the arrow tooth 1 is in contact with the workpiece, a front surface of the cutter tip 3 bears 100% of the shear resistance of the workpiece, at which time, an area of the cutter tip can be regarded as zero; and then cutting is continued along the arrow tooth edges 4. At this time, the actual thickness of the arrow tooth edge 4, that is, the cutter point, is 0.087 mm, which is more than one order of magnitude less than a blunting value of 1.0 mm. Although the arrow tooth edge 4 is not as sharp as a new cutter point of the straight tooth, the value is still within an optimal peak performing range, and high-quality shearing still can be achieved. In fact, an operation time of the straight tooth with maximal sharpness is brief, the cutter point is quickly blunted into a small arc, and most of the high-quality shearing of a straight tooth is completed with the cutter point within the peak performing interval.

The actual thickness k of the arrow tooth edge 4 is consistent at all levels throughout its height, so that the arrow tooth 1 can perform high-quality continuous cutting at any height without grinding. Since the arrow tooth tail 7 gradually shrinks from top to bottom of the tooth along its height, when the arrow tooth 1 height decreases due to sawing wear, the arrow tooth angle 2 narrows as well, thereby making the shearing quality better rather than worse.

The arrow tooth 1 implements shearing by greatly reducing resistance, and the wear rate is greatly reduced proportional to the reduction of the resistance.

When the arrow tooth angle 2 is set at 12 degrees, the maximum resistance of the arrow tooth 1 is reduced to 10.453% of the corresponding straight tooth; when the arrow tooth angle 2 is 10 degrees, the maximum resistance of the arrow tooth 1 is reduced to 8.7% of the corresponding straight tooth; when the arrow tooth angle 2 is 8 degrees, the maximum resistance of the arrow tooth is reduced to 6.98% of the corresponding straight tooth; when the arrow tooth angle 2 is 6 degrees, the maximum resistance of the arrow tooth 1 is reduced to 5.23% of the corresponding straight tooth; and when the arrow tooth angle 2 is 4 degrees, the maximum resistance of the arrow tooth 1 is reduced to only 3.5% of the corresponding straight tooth.

### Embodiment 2

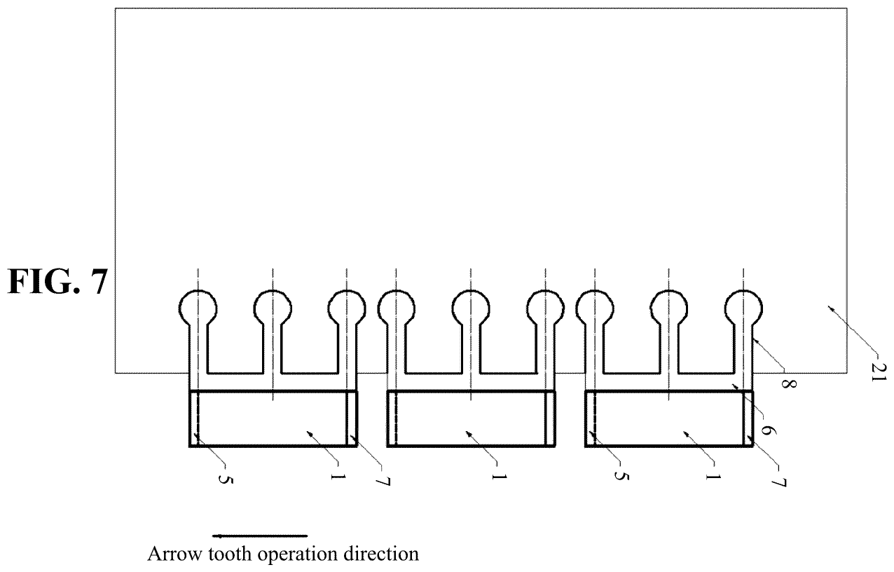

As shown in FIG. 7 of the specification, the arrow tooth 1 with the 10-degree arrow tooth angle 2 is selected to form an arrow tooth band saw. At this time, the structure and operation of the arrow tooth 1 are completely the same as the arrow tooth 1 of the circular saw in Embodiment 1, except that the bottom surfaces of the arrow tooth 1 and the arrow tooth disk 6 are changed from an arc to a straight line, and the arrow tooth root 8 is changed correspondingly.

The foregoing is merely illustration of the preferred embodiments of the present invention and is not intended to limit the present invention. For those skilled in the field of shearing, the present invention may have various modifications and changes and be applied to different occasions, for example, the arrow-shaped cutter can be applied to planer blades, planer knives and lathe tools. Any modifications, equivalent substitutions, improvements, etc. made within the spirit and scope of the present invention should be included within the protection scope of the present invention.

What is claimed is:

1. An arrow tooth saw having an arrow-shaped cutter tooth, characterized in that, comprising: an arrow tooth unit, wherein the arrow tooth unit comprises an arrow tooth (1), an arrow tooth angle (2), an arrow tooth tip (3), arrow tooth edges (4), an arrow tooth head (5) and an arrow tooth tail (7); and a top view structure of the arrow tooth (1) meets the following conditions: a rectangular element C is arranged on each of two sides of a center line of the arrow tooth (1), a length of the rectangular element C is an original thickness a of each of the arrow tooth edges, heights of two rectangular elements C perpendicular to the center line of the arrow tooth (1) form an arrow tooth width, the rectangular elements C is stretched into a parallelogram under a condition of keeping the height of the rectangular element C unchanged in a center line direction until an included angle between a hypotenuse of the parallelogram and the center line of the arrow tooth (1) is half of an angle of the arrow tooth angle (2), and at this time, an entity figure surrounded by two parallelograms forms the arrow tooth (1); or the arrow tooth angle (2) horizontally translates along the center line of the arrow tooth (1) by a distance of the original thickness a of one arrow tooth edge (4), and all acute angles and sides thereof generated in a translation process form the arrow tooth (1).

2. The arrow tooth saw having the arrow-shaped cutter tooth according to claim 1, characterized in that, the arrow tooth angle (2) is acute; the arrow tooth (1) is formed by stretching a bottom view of the arrow tooth (1) upward along an increasing radius of a circular saw blade in an arrow tooth height h; a width of the arrow tooth tail (7) gradually shrinks from top to bottom, with a maximum value being an top width m of the arrow tooth (1) and a minimum value being a bottom width n of the arrow tooth (1); widths of other parts of the arrow tooth (1) are formed in a plane by countless gradually enlarging connecting lines which are perpendicular to the center line of the arrow tooth (1) or parallel to a baseline of the arrow tooth (1) between two lines formed from the arrow tooth tip (3) to the arrow tooth tail (7); an effective length b of the arrow tooth (1) is a height of a triangle formed by a bottom view of each arrow tooth (1); and a vertical shear resistance of the arrow tooth edges (4) decreases with the decrease of the arrow tooth angle (2).

3. The arrow tooth saw having the arrow-shaped cutter tooth according to claim 2, characterized in that, further comprising an arrow tooth saw unit, wherein the arrow tooth saw unit comprises a saw blade body (21); an arrow tooth disk (6) is arranged on a bottom surface of the arrow tooth (1); a minimum value of a width of the arrow tooth tail (7) is greater than a width of the arrow tooth disk (6); and the width of the arrow tooth disk (6) is greater than or equal to a width of the saw blade body (21).

4. The arrow tooth saw having the arrow-shaped cutter tooth according to claim 3, characterized in that, front and rear arrow tooth roots (8), or front, middle and rear arrow tooth roots (8) are arranged below the arrow tooth disk (6); a tail end of each arrow tooth root (8) is enlarged into a cylinder or a square column; a guide edge is arranged at a periphery of a side of the arrow tooth root (8); and arrow tooth root holes (28) are formed in an outer edge (24) of the saw blade body (21), and a guide groove is formed at a periphery of a side of each of the arrow tooth root holes (28).

5. The arrow tooth saw having the arrow-shaped cutter tooth according to claim 4, characterized in that, the arrow tooth (1), the arrow tooth disk (6) and the arrow tooth roots (8) are respectively welded firmly into a whole body in pairs after being respectively processed; then all the arrow tooth roots (8) of all the arrow teeth (1) and all the arrow tooth root holes (28) of the saw blade body (21) are subjected to one-step pressure injection and mounting; or the arrow tooth disk (6) is directly welded with an outermost arc or edge of the saw blade body (21).

6. The arrow tooth saw having the arrow-shaped cutter tooth according to claim 5, characterized in that, a work operating direction of the arrow tooth (1) is only from the arrow tooth head (5) to the arrow tooth tail (7); and a warning mark is labeled on the saw blade body (21), so that the saw blade body (21) is unable to be mounted reversely to cause a reverse operation.
